(19) United States
(12) Patent Application Publication
(10) Pub. No.: US 2010/0053651 A1
(43) Pub. Date: Mar. 4, 2010

(54) Image Processing Device and Image Processing Method

(75) Inventor: Satoru ONO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/544,795

(22) Filed: Aug. 20, 2009

(30) Foreign Application Priority Data
Aug. 27, 2008 (JP) 2008-218470

(51) Int. Cl. G06F 15/00

(52) U.S. Cl. 358/1.9

(57) ABSTRACT

Provided is an image processing device which executes a color conversion process of converting a color space of received image data into a color space of an output device for outputting image data, the image processing device including: input/standard color conversion information generated with respect to a plurality of input color spaces of the received image data, for converting the input color spaces into a standard color image which does not depend on the output device; and a control unit generating input/output color conversion information for converting the input color spaces into an output color space from standard/output color conversion information for converting the standard color space into the output color space which is the color space of the output device and the input/standard color conversion information, and executing the color conversion process using the input/output color conversion information.

### BACKGROUND

1. Technical Field

The present invention relates to an image processing device for converting a color space of received image data, or the like, and, more particularly, to an image processing device capable of facilitating the design of a profile for a color space conversion process and suppressing the holding capacity of the profile.

2. Related Art

In general, when an image is output from a printer or the like, a color (space) conversion process for representing a color space suitable for a color material used in the printer is performed with respect to image data to be output. In the color conversion process, a lookup table (LUT) in which color values of a color space after conversion corresponds to color values of a color space after conversion is prepared in advance and the process is executed by referring to the LUT.

In a general printer output, the image data to be output is converted into a standard color space used generally, in a printer driver or a previous step thereof and is then transmitted to the printer. In this case, the color conversion from the standard color space into the color space used in the printer is executed by the LUT and held in advance.

In the printer output for the purpose for checking hue before mass printing using a rotary press or the like, image data used for mass printing is input to the printer without change. Thus, in the printer, in order to cope with various color spaces of input data, LUTs are respectively prepared with respect to such color spaces.

Image processing using a LUT is disclosed in JP-A-2005-286904.

The color space used in the above-described printer depends on a color material used in the printer or the like, and generally depends on the model of the printer. Accordingly, as described above, in a printer for processing image data represented by a plurality of color spaces, LUTs for converting input color spaces into color spaces depending on the model of the printer need to be respectively prepared and held in the input color spaces. However, since the plurality of LUTs differs per model, the plurality of LUTs needs to be designed according to the models.

Even in the color conversion of the same color space, processing contents may be changed according to the kind of an image. For example, a text LUT and an image LUT may be prepared with the same color space. In this case, the number of the plurality of LUTs is further increased and a large storage capacity for holding the LUTs in the printer is necessary.

### SUMMARY

An advantage of some aspects of the invention is that it provides an image processing device for converting a color space of received image data, which is capable of facilitating the design of a profile for a color space conversion process and suppressing a holding capacity of the profile.

According to an aspect of the invention, there is provided an image processing device which executes a color conversion process of converting a color space of received image data into a color space of an output device for outputting image data, the image processing device including: a holding unit that holds input/standard color conversion information generated with respect to a plurality of input color spaces of the received image data, for converting the input color spaces into a standard color image which does not depend on the output device; and a control unit generating input/output color conversion information for converting the input color spaces into an output color space from standard/output color conversion information for converting the standard color space into the output color space which is the color space of the output device and the input/standard color conversion information, and executing the color conversion process using the input/output color conversion information.

In the invention, the standard/output conversion information may be held in another image processing device for an output device of the same model as the output device.

In the invention, the standard color space may be a RGB color space and the output color space may be a CMYK color space.

In the invention, plural pieces of standard/output color conversion information may be prepared for the kinds of image object.

According to another aspect of the invention, there is provided an image processing method of an image processing device which executes a color conversion process of converting a color space of received image data into a color space of an output device for outputting image data, the method including: generating input/output color conversion information for converting input color spaces into an output color space from input/standard color conversion information generated with respect to a plurality of input color spaces which is the color space of the received image data, for converting the input color spaces into a standard color image which does not depend on the output device, and standard/output color conversion information for converting the standard color space into an output color space which is the color space of the output device, and executing the color conversion process using the input/output color conversion information.

Other objects and features of the invention will become apparent from the following embodiments.

### BRIEF DESCRIPTION OF THE DRAWINGS

The invention will be described with reference to the accompanying drawings, wherein like numbers reference like elements.

FIG. 1 is a view showing the configuration of a printer including an image processing device according to an embodiment of the invention.

FIG. 2 is a view explaining the outline of a color conversion process of controllers.

FIG. 3 is a flowchart showing a process after a system B starts up.

FIG. 4 is a flowchart showing a process after the system B starts up, according to Modified Example 1.

FIG. 5 is a flowchart showing a process after the system B starts up, according to Modified Example 2.

FIG. 6 is a flowchart showing a process after the system B starts up, according to Modified Example 3.

### DESCRIPTION OF EXEMPLARY EMBODIMENTS

Hereinafter, the embodiments of the invention will be described with reference to the accompanying drawings. However, such embodiments do not restrict the technical scope of the invention. In the drawings, the same or similar components are denoted by the same reference numerals or symbols.

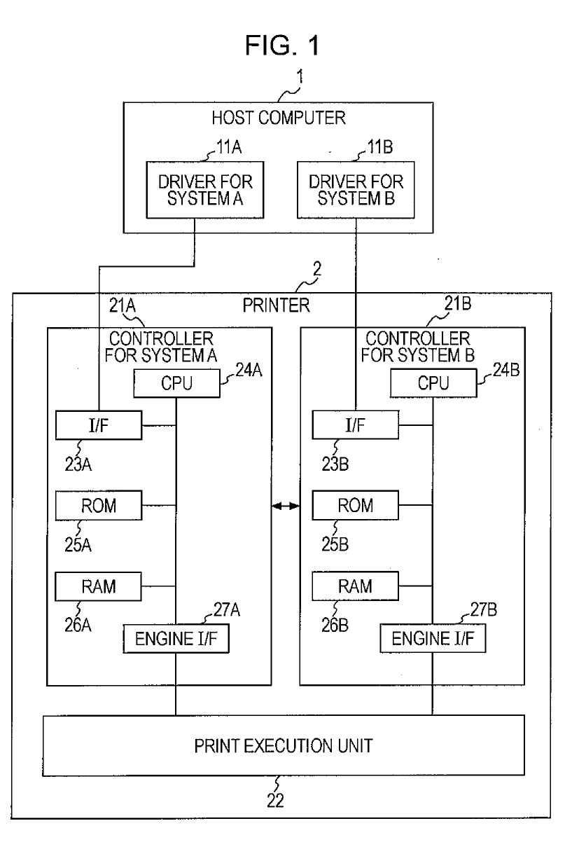

FIG. 1 is a view showing the configuration of a printer including an image processing device according to an embodiment of the invention. A controller 21B for a system B shown in FIG. 1 is an image processing device according to the invention, which holds a color conversion LUT (input/standard color conversion information) from a plurality of color spaces (which are called input color spaces) of input image data into a R (red), G (green), and B (blue) color space (which is called a standard color space) used generally, generates a LUT (input/output color space information) for converting the input color spaces into an output color space using the color conversion LUT (standard/output color conversion information) from the RGB color space into a color space (which is called an output color space, for example, C (cyan), M (magenta), Y (yellow), and K (black) color space) used in the output of the printer 2, which is held by a controller 21A for a system A in the same printer 2, and executes a color conversion process of a received print job by the generated LUT. In this way, the LUT held by the controller 21B for system B does not depend on the model of the printer 2 and the LUT does not need to be designed according to the models.

A host computer 1, shown in FIG. 1, is a host device of the printer 2 for performing a printing request with respect to the printer 2 and is configured by a computer system such as a personal computer. As described below, since the printer 2 has the system A and the system B and shares a print execution unit 22 but is configured as if two printers are present, the hot computer 1 includes a driver 11A for the system A and a driver 11B for the system B, which are two printer drivers respectively corresponding to the systems.

Each of the printer drivers generates print data to be printed and transmits it to the system of the printer 2 corresponding thereto, in response to a print instruction operation of a user. The print data includes a control command for print control and image data of an image to be printed. Image data represented by the RGB color space generally is transmitted from the driver 11A for the system A, and image data of various color spaces is transmitted from the driver 1B for the system B. For example, image data represented by RGB(2) which is different from the generally used RGB, CMYK(2) and CMYK(3) which are different from CMYK of the output color space, or Lab are transmitted. In addition, even in CMYK, if the color materials such as inks, toners, or the like, differ, density gradation values of the respective colors differ when the same color is represented. Accordingly, the above-described CMYK, CMYK(2) and CMYK(3) are present.

The print data is herein represented by, for example, a page description language and is transmitted to the printer 2. In addition, each of the driver 11A for the system A and the driver 11B for the system B is configured by a driver program describing the above process and a control device for executing the process according to the program.

Next, the printer 2 is a printing device for receiving print data transmitted from the host computer 1 and executing printing and is herein, for example, a laser printer for executing printing in page units. As described above, two systems are mounted in the present printer 2. The system A is a so-called standard system for performing the process with respect to image data represented by the standard color space (RGB), and the system B is a so-called individual system for performing the process with respect to the image data represented by individual color spaces (input color spaces).

As shown in FIG. 1, the printer 2 includes the two controllers corresponding to the two systems, that is, the controller 21A for the system A and the controller 21B for the system B, and the print execution unit 22 for executing the printing process using the toners of CMYK.

As shown in FIG. 1, the controllers 21A and 21B include I/Fs 23A and 23B, CPUs 24A and 24B, ROMs 25A and 25B, RAMs 26A and 26B, and engine I/Fs 27A and 27B.

The I/Fs 23A and 23B perform interface with the host computer 1 including the reception of the print data transmitted from the host computer 1.

The ROMs 25A and 25B store a variety of programs or data for performing the process performed by the controllers 21A and 21B and stores the above-described LUT therein as information for the color conversion process. As described above, the LUT is a lookup table in which color values of the color space before conversion respectively correspond to color values of color space after conversion and, more particularly, multi-dimensional values (color values) represented by the density gradation values of the respective colors (for example, R, G and B) configuring the color space in the color space (for example, RGB) before conversion respectively corresponds to multi-dimensional values (color values) represented by the density gradation values of the respective colors (for example, C, M, Y and K) configuring the color space in the color space (for example, CMYK) after conversion.

The ROM 25A stores the color conversion LUT from the standard color space into the output color space “RGB to CMYK LUT”, and the ROM 25B stores the color conversion LUT from the input color spaces into the standard color space, for example, “RGB(2) to RGB LUT”, “CMYK(2) to RGB LUT”, “CMYK(3) to RGB LUT” and “Lab to RGB LUT”. As described above, if different LUTs are used for an image and a text, the ROM 25A of the system A stores a “RGB to CMYK LUT” for the image and a “RGB to CMYK LUT” for the text.

The RAMs 26A and 26B are memories for storing the received print data, image data after image processing and so on, and the image data of each page which is subjected to the printing process by the print execution unit 22 is guided from the RAMs to the engine I/Fs 27A and 27B. As described below, in the system B, a process of synthesizing the LUT stored in the ROM 25B and the LUT held by the system A so as to generate a new LUT is executed, and the generated LUT is held in the RAM 26B.

The CPUs 24A and 24B control various processes performed by the systems of the present printer 2, and, more particularly, perform a process of executing predetermined image processing with respect to the image data included in the received print data and storing it in the RAMs 26A and 26B, a process of analyzing a control command included in the print data and instructing an adequate printing process to the print execution unit 22, and a process of controlling an operation unit for forming the interface with the user. The present printer 2 is characterized in the color space conversion process performed by the CPU 24B and the detailed contents thereof will be described later. In addition, the processes executed by the CPUs 24A and 24B are mainly performed according to the programs stored in the ROMs 25A and 25B.

Next, the engine I/Fs 27A and 27B read the image data stored in the above-described RAMs 26A and 26B at predetermined timings when printing is executed by the print execution unit 22, guide it to the print execution unit 22 after the predetermined processes are performed, and perform an interface between the controllers 21A and 21B and the print execution unit 22. In addition, each of the engine I/Fs 27A and 27B includes, although not shown, a memory for temporarily storing data, a thawing unit, and a screen processing unit. The thawing of the compressed data and the screen processing for conversion into data of dots are performed with respect to the image data read from the RAMs 26A and 26B. In addition, each of the engine I/Fs 27A and 27B is more particularly composed of an ASIC.

The print execution unit 22 executes a printing process based on the data output from the engine I/Fs 27A and 27B and forms an image on a printing medium such as paper. The print execution unit 22 includes a charging unit, an exposure unit, a development unit, a transfer unit and so on (not shown), similar to a general laser printer. The development unit includes toners of respective colors of CMYK.

The present printer 2 having the above-described configuration is characterized in the color space conversion process of the received image data and the detailed processing contents thereof will now be described. First, the outline of the conversion method will be described.

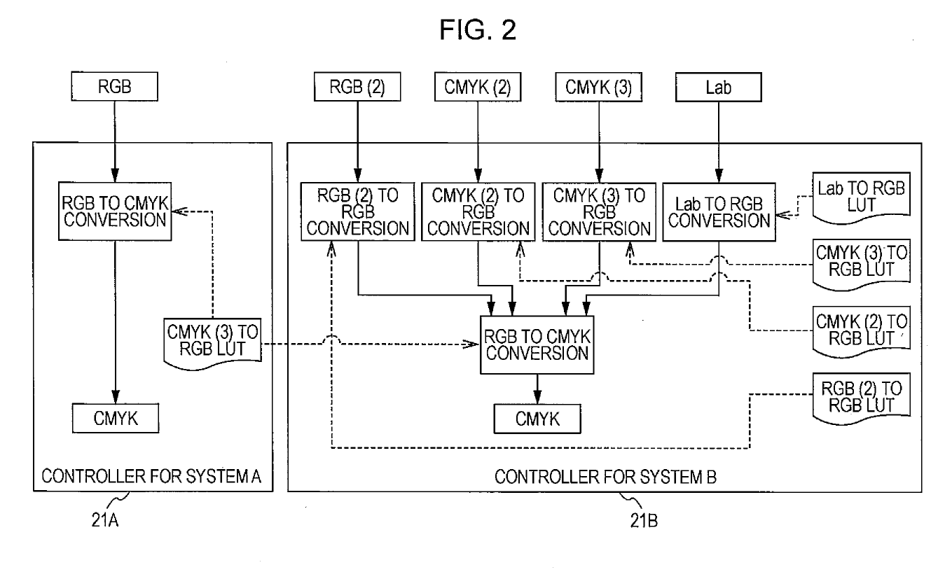

FIG. 2 is a view explaining the outline of the color conversion process of the controllers 21A and 21B. In the controller 21A for the system A shown on the left side of FIG. 2, the image data represented by RGB which is the standard color space is received, as described above. Thereafter, the received image data is converted into the image data represented by CMYK which is the output color space, using the “RGB to CMYK LUT” in the controller 21A for the system A, and the color conversion process is finished.

Meanwhile, in the controller 21B for the system B shown on the right side of FIG. 2, the image data represented by various color spaces (input color spaces) is received. The input color spaces of the received image data need to be converted into CMYK which is the output color space. However, in the controller 21B for the system B, the conversion process is performed in cooperation with the controller 21A for the system A. In more detail, the conversion process is performed using the above-described LUTs (“RGB(2) to RGB LUT”, “CMYK(2) to RGB LUT”, “CMYK(3) to RGB LUT” and “Lab to RGB LUT”) held in the controller 21B for the system B and the LUT (“RGB to CMYK LUT”) stored in the controller 21A for the system A.

As described below, the conversion from the input color spaces into the output color space may be performed once using one synthetic LUT or twice using two LUTs. In either case, as shown in FIG. 2, the LUTs held in the controller 21B for the system B are used with respect to the portion corresponding to the conversion from the input color spaces into the standard color space RGB, and the LUT stored in the controller 21A for the system A is used with respect to the portion corresponding to the conversion from the standard color space RGB into the output color space CMYK.

For example, if the input color space is RGB(2), the “RGB(2) to RGB LUT” held in the controller 21B for the system A and the “RGB to CMYK LUT” of the system A are used such that the image data of the output color space CMYK is generated. Even in the other input color spaces, the image data is similarly converted.

The LUT associated with CMK depending on the model of the printer 2 (print execution unit 22) is not held in the system B and that LUT is held in the system A. This point is a big feature.

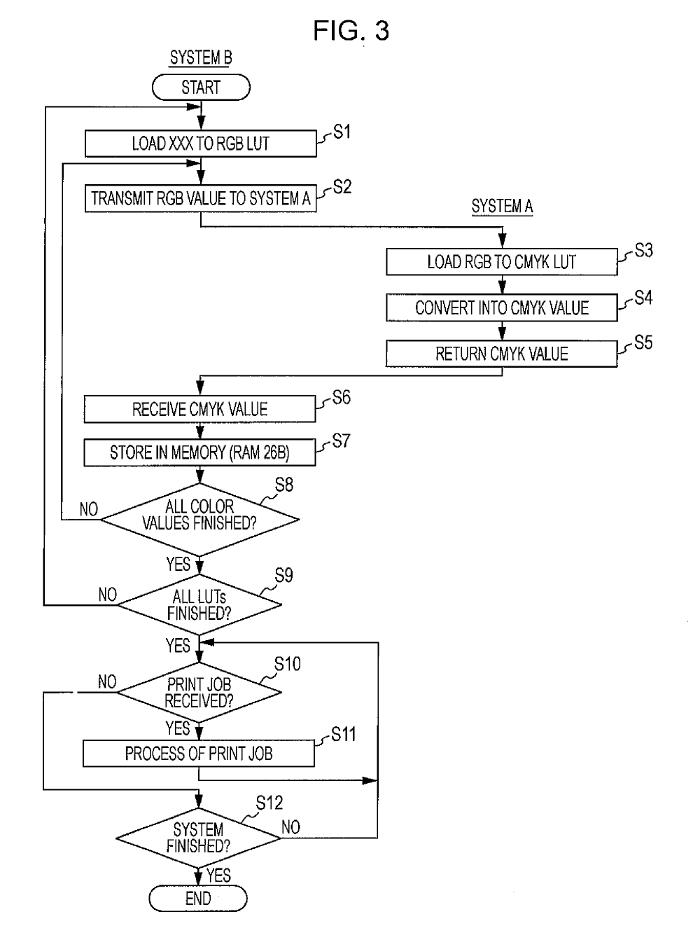

Next, the detailed processing contents of the color conversion process will be described. FIG. 3 is a flowchart showing a process after the system B starts up. First, when the system B starts up, in the controller 21B for the system B, the CPU 24B loads any one “XXX to RGB LUT” of the above-described LUTs stored in the ROM 25B to the RAM 26B (step S1).

The CPU 24B transmits the RGB value after conversion, corresponding to one color value before conversion, in the loaded LUT to the system A (step S2).

When the transmission is performed, in the system A, the CPU 24A loads the “RGB to CMYK LUT” stored in the ROM 25A to the RAM 26A (step S3). The CPU 24A converts the transmitted RGB value to a CMYK value using the loaded LUT (step S4). Thereafter, the CPU 24A returns the CMYK value to the system B (step S5).

The system B receives the returned CMYK value (step S6), the CPU 24B stores the received CMYK value in the RAM 26B in correspondence with the color value before conversion of the transmitted RGB value (step S7). That is, the CMYK value corresponding to one color value of one input color space XXX is stored as one piece of information of “XXX to CMYK LUT” which is the LUT obtained by synthesizing “XXX to RGB LUT” and “RGB to CMYK LUT”.

When the above process from the step S2 to the step S7 is executed with respect to all the color values before conversion of the loaded “XXX to RGB LUT” (Yes of step S8), the synthetic LUT “XXX to CMYK LUT” is generated and held in the RAM 26B.

The process (steps S1 to S8) of generating the synthetic LUT is executed with respect to all the LUTs held in the system B and all synthetic LUTS are held in the RAM 26B (Yes of step S9). That is, herein, “RGB(2) to CMYK LUT”, “CMYK(2) to CMYK LUT”, “CMYK(3) to CMYK LUT” and “Lab to CMYK LUT” are generated and held.

As described above, if a plurality of LUTs held in the system A for an image and a text is present, the process from the step S2 to Yes of the step S8 is executed with respect to the “XXX to RGB LUT” for each of the LUTs held in the system A, and synthetic LUTs are generated and held by the number of LUTs.

When the synthetic LUTs are generated by the above process, the controller 21B for the system B waits for the reception of a print job (step S10), and, when the print job has been received (Yes of step S10), the process for the print job is executed (step S11). In more detail, the image data of the print job described by a page description language is set to an intermediate code. Thereafter, a development process is performed with respect to the intermediate code so as to generate image data, of which pixels have the density gradation values of the respective colors. Since the pixels of the generated image data are represented by the input color spaces, the color conversion process of the image data is executed using the generated synthetic LUTs. By this process, the image data represented by the output color space is generated and the image data is held in the RAM 26B. Thereafter, the image data is read according to the processing timings of the print execution unit 22, and the processed signal is transmitted to the print execution unit 22 after the process of the above-described engine I/F 27B is performed. Thereafter, printing onto the printing medium is executed by the print execution unit 22 and the process for the received print job is finished.

When the process of the received print job has been finished, the controller 21B for the system B waits for the reception of the next print job (S10). However, when a situation in which the system B should be finished before the print job is received occurs (No of step S10 and Yes of step S12), the system B is finished. For example, when the system A has received a print job, the system B is finished. When the system B has been finished, the matter held in the RAM 26B is erased. Thereafter, when the system B starts up again, the above process from the step S1 is performed and the synthetic LUTs are held in the RAM 26B.

In addition, the generated synthetic LUTs may be stored in a non-volatile memory or an HD and the process of generating the synthetic LUTs may be performed only when the system B is initially used.

Next, a modified example (Modified Example 1) of the above-described embodiment will be described. Modified Example 1 is different from the above-described embodiment in that the LUT held by the system A is transmitted to the system B in the process of generating the synthetic LUTs of the system B.

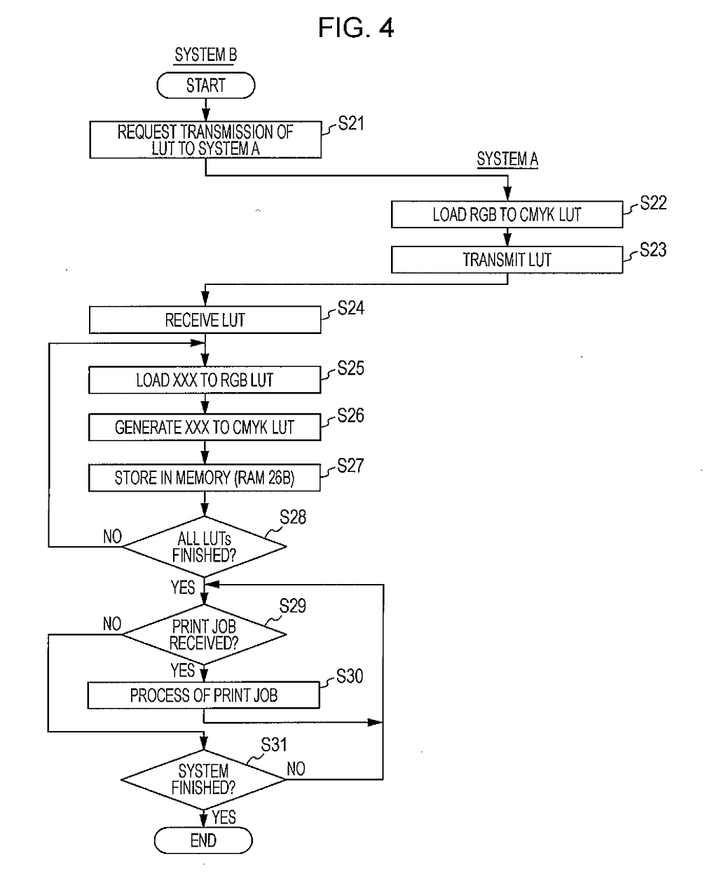

FIG. 4 is a flowchart showing a process after the system B starts up, according to Modified Example 1. When the system B starts up, first, the CPU 24B requests the transmission of the LUT held by the system A to the system A (step S21). The system A receives the requests and loads the LUT held by the CPU 24A to the RAM 26A (step S22) and transmits (information about) the LUT to the system B (step S23). The CPU 24B receives and holds the transmitted LUT in the RAM 263 (step S24).

Next, the CPU 24B loads any one (“XXX to RGB LUT”) of the LUTs stored in the ROM 25B to the RAM 26B (step S25). Then, the synthetic LUT “XXX to CMYK LUT” is generated from the received LUT, that is, “RGB to CMYK LUT” and “XXX to RGB LUT” (step S26). In more detail, the RGB value corresponding to each color value of the input color spaces XXX is obtained from “XXX to RGB LUT” and the CMYK value corresponding to the RGB value is then obtained from “RGB to CMYK LUT” such that the obtained CMYK value corresponds to the initial color value. The generated synthetic LUT is stored in the RAM 26B (step S27).

The synthetic LUT generating process (steps S25 to S27) is performed with respect to all the LUTs held in the system B. Even in this case, all the synthetic LUTs “RGB(2) to CMYK LUT”, “CMYK(2) to CMYK LUT”, “CMYK(3) to CMYK LUT” and “Lab to CMYK LUT” are generated and held.

In addition, if a plurality of LUTs held in the system A for an image and a text is present, the process from the step S25 to the step S27 is executed with respect to “XXX to RGB LUT” for each of the LUTs held by the system A and synthetic LUTs are generated and held by the number of LUTs.

The process after that, that is, the process from the step S29 to Yes of the step S31, is equal to the process from the step S10 to the step S12.

Even in this case, when the system B has been finished, the matter held in the RAM 26B is erased. Therefore, the generated synthetic LUTs may be stored in a non-volatile memory or an HD and the process of generating the synthetic LUTs may be performed only when the system B is initially used.

Next, another modified example (Modified Example 2) will be described. Modified Example 2 is different from the above-described example in that the system B does not generate the synthetic LUTs, but uses the LUTs held therein and the LUT held in the system A in the color conversion process of the received print job.

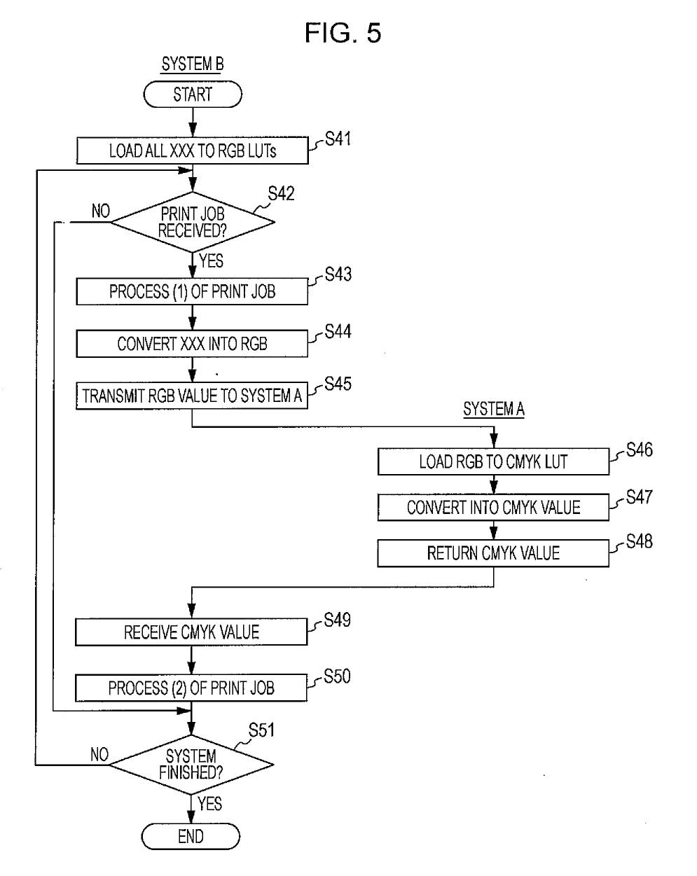

FIG. 5 is a flowchart showing a process after the system B starts up, according to Modified Example 2. When the system B starts up, the CPU 24B loads all the LUTs (“XXX to RGB LUT”) held in the ROM 25B to the RAM 26B (step S41).

Thereafter, the reception of a print job is waited for and, when the print job has been received (Yes of step S42), the CPU 24B executes the overall process of the received print job (step S43). In more detail, as described above, the image data of the print job described by a page description language is set to an intermediate code. Thereafter, a development process is performed so as to generate image data of which pixels have density gradation values of respective colors.

Since the pixels of the generated image data are represented by the input color spaces, the CPU 24B converts the color space of the image data into RGB using the loaded LUT for the input color spaces (step S44). That is, the image data of the print job is represented by RGB. Thereafter, the CPU 24B transmits the RGB value after conversion to the system A (step S45).

When the RGB value has been received, the CPU 24A of the system A loads “RGB to CMYK LUT” held therein to the RAM 26A (step S46) and converts the received RGB value to a CMYK value using the loaded LUT (step S47). When the conversion for all the data has been finished, the CMYK value after conversion returns to the system B (step S48)

The CPU 24B of the system B receives the CMYK value (step S49) and holds the image data of the print job in the RAM 26B as data represented by CMYK.

Thereafter, the second half process of the print job is executed (step S50). That is, as described above, the image data is read according to the processing timings of the print execution unit 22, and the processed signal is transmitted to the print execution unit 22 after the process of the above-described engine I/F 27B is performed. Thereafter, printing onto the printing medium is executed by the print execution unit 22 and the process for the received print job is finished.

The controller 21B for the system B waits for a next print job. When a print job has been received, the process from the step S43 is executed. Meanwhile, when a situation in which the system B should be finished before the print job is received occurs (No of step S42 and Yes of step S51), the system B is finished.

In addition, if a plurality of LUTs held in the system A is present by the kind of object, such as an image and text, the RGB value is transmitted from the system B (S45) according to attribute values for identifying the object kinds, and the system A performs a conversion process using a suitable LUT according to the attribute value.

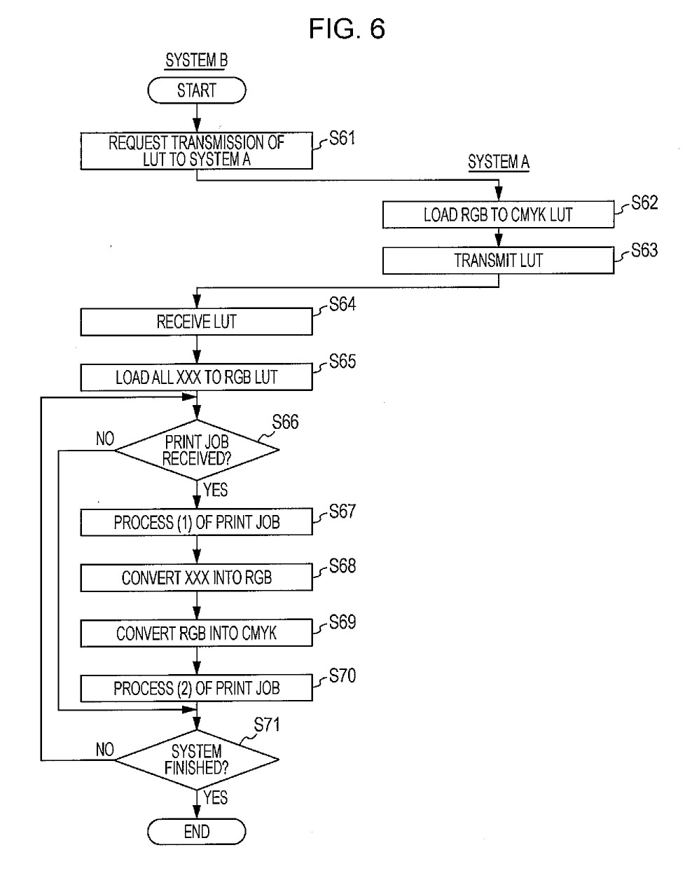

Next, another modified example (Modified Example 3) will be described. Modified Example 3 is different from Modified Example 2 in that the LUT held by the system A is first transmitted to the system B. FIG. 6 is a flowchart showing a process after the system B starts up, according to Modified Example 3.

When the system B starts up, in the controller 21B for the system B, first, the CPU 24B requests the transmission of the LUT held by the system A to the system A (step S61). The system A receives the requests and loads the LUT held by the CPU 24A to the RAM 26A (step S62) and transmits (information about) the LUT to the system B (step S63). The CPU 24B receives and holds the transmitted LUT in the RAM 26B (step S64).

Thereafter, the CPU 24B loads all the LUTs held in the ROM 25B to the RAM 26B, similar to Modified Example 2 (step S65).

Thereafter, the reception of a print job is waited for and, when the print job has been received (Yes of step S66), the CPU 24B executes the first half process of the received job, similar to Modified Example 2 (step S67).

Since the pixels of the generated image data are represented by the input color spaces, similar to Modified Example 2, the CPU 24B converts the color space of the image into RGB using the loaded LUT for the input color spaces (step S68).

Next, the CPU 24B converts the image data converted into the RGB value into a CMYK value using “RGB to CMYK LUT” held by the system A, which is loaded to the RAM 26A (step S69).

Thereafter, similar to Modified Example 2, the second half process of the print job is executed (step S70).

Thereafter, a next print job is waited for, and, when the print job has been received, the controller 21B for the system B executes the process from the step S67. Meanwhile, when a situation in which the system B should be finished before the print job is received occurs (No of step S66 and Yes of step S71), the system B is finished.

In addition, if a plurality of LUTs held in the system A is present by object kinds, such as an image and a text, the process is performed using the LUT suitable for each of the object kinds when the RGB value is converted into the CMYK value (S69).

As described above, in the controllers 21A and 21B of the printer 2 of the embodiment and the modified examples thereof, since the LUT associated with the color space depending on the model of the printer out of the held LUTs for color conversion is only the “RGB to CMYK LUT” held by the system A, that is, the LUT which should be changed by the model of the printer is only that LUT, the design of the LUTs according to the models is facilitated.

In the controller 21B for the system B, since the held LUTs do not depend on the model of the printer, they may be used for any model of printer. Accordingly, the LUTs may be used in the design of other models of printers, without change. In addition, if the controller portion is composed of an attachable/detachable board, it may be mounted and used in another printer having the configurations of the systems A and B of the present printer 2 without any modification, as the controller for the system B.

In the LUTs by the number of input color spaces included in the system B, since the color value after conversion is a three-dimensional RGB value, it is possible to suppress the amount of data held, compared with the exiting method of holding the LUTs in which the output color space is CMYK, that is, the case where the LUTs (color value after conversion is four dimensional) convert the input color spaces into CMYK by the number of input color spaces. As described above, even when the LUT is changed by the kind of image object, it is changed to the LUT held by the system A and only one type of LUT is held in the system B. Accordingly, even in this case, it is possible to suppress the amount of data held.

In the present embodiment and the modified examples thereof, the LUT for converting the input color space into the RGB color space of the data received by the system A, that is, the RGB color space was used as the intermediate space (standard color space) of the color conversion process. Another color space which does not depend on the model of the printer, such as Lab, may be used as the intermediate color space. In this case, an LUT for converting the intermediate color space different from the color space of the data received by the system A into the output color space is provided and the same color conversion process using the LUT is performed in the system B. However, in this case, in the system A, the output color space needs to be further converted after the RGB color space into the intermediate color space. Accordingly, the process of the system A may be increased.

The range of the invention is not limited to the above-described embodiment and includes the equivalent of the invention described in the claims.

The entire disclosure of Japanese Patent Application No. 2008-218470, filed Aug. 27, 2008 is expressly incorporated by reference herein.

What is claimed is:

1. An image processing device which executes a color conversion process of converting a color space of received image data into a color space of an output device for outputtting image data, the image processing device comprising:
a holding unit that holds input/standard color conversion information generated with respect to a plurality of input color spaces of the received image data, for converting the input color spaces into a standard color image which does not depend on the output device; and
a control unit generating input/output color conversion information for converting the input color spaces into an output color space from standard/output color conversion information for converting the standard color space into the output color space which is the color space of the output device and the input/standard color conversion information, and executing the color conversion process using the input/output color conversion information.

2. The image processing device according to claim 1, wherein the standard/output conversion information is held in another image processing device for an output device of the same model as the output device.

3. The image processing device according to claim 1, wherein the standard color space is a RGB color space and the output color space is a CMYK color space.

4. The image processing device according to claim 1, wherein plural pieces of standard/output color conversion information are prepared for the kinds of image object.

5. An image processing method of an image processing device which executes a color conversion process of converting a color space of received image data into a color space of an output device for outputting image data, the method comprising:
generating input/output color conversion information for converting input color spaces into an output color space from input/standard color conversion information generated with respect to a plurality of input color spaces which is the color space of the received image data, for converting the input color spaces into a standard color image which does not depend on the output device, and standard/output color conversion information for converting the standard color space into an output color space which is the color space of the output device, and executing the color conversion process using the input/output color conversion information.
